(19) United States
(12) Patent Application Publication
(10) Pub. No.: US 2026/0245274 A1
(43) Pub. Date: Aug. 20, 2026

(54) EFFECTS GENERATION MODEL

(71) Applicant: Bytedance Technology Ltd., Grand Cayman (KY)

(72) Inventors: Yulei NIU, Los Angeles, CA (US); Fan CHEN, Los Angeles, CA (US); Lexin TANG, Los Angeles, CA (US); Xinyao WANG, Los Angeles, CA (US); Longyin WEN, Los Angeles, CA (US)

(21) Appl. No.: 19/057,767

(22) Filed: Feb. 19, 2025

(51) Int. Cl. G06T 11/60; G06F 16/245; G06V 40/16

(52) U.S. Cl. CPC G06T 11/60; G06F 16/245; G06T 2200/24; G06V 40/174

(57) ABSTRACT

A computing system receives a user query and inputs the user query into a language model to generate domain-specific language code based on the user query. The system then generates a subgraph based on the domain-specific language code, assembles the subgraph into a package, and generates a visual effect by executing the package.

### BACKGROUND

Visual effects are the creation, manipulation, or enhancement of imagery using digital tools to achieve a desired visual result. These effects are used to engage audiences across various applications in entertainment and media. In social media applications, visual effects such as animations, color transformations, filters, overlays, text stylizations, and dynamic transitions provide a creative and interactive way for users to personalize their content.

Traditional methods of generating visual effects often require users to navigate complex menus and manually adjust numerous parameters, which can be time-consuming and unintuitive for users who desire quick, efficient, and personalized customization of their visual effects.

### SUMMARY

In view of the above issues, a computing system is provided for generating a visual effect. The computing system includes processing circuitry and memory storing an effects generation model and instructions that, when executed, cause the processing circuitry to receive a user query and input the user query into a language model to generate domain-specific language code based on the user query. The system generates a subgraph based on the domain-specific language code, assembles the subgraph into a package, and generates the visual effect by executing the package.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a first example computing system according to an example of the present disclosure.

FIG. 2 illustrates a schematic view of the operations of the effects generation model of the computing system of FIG. 1.

FIG. 3 illustrates a detailed schematic of a first example of the inputs and outputs of the query rewriter, the event retriever, the node retriever, the text-to-logic language model, and the subgraph generator of FIGS. 1 and 2.

FIG. 4 illustrates a detailed schematic of a user query and a response, including an effect and a natural language response, outputted by the effects generation model in the first example of FIG. 3.

FIG. 5 illustrates a schematic view of a second example computing system for training the text-to-logic language model of FIGS. 1 and 2 according to an example of the present disclosure.

FIG. 6 is a flow chart of a first method for generating an effect according to an example embodiment of the present disclosure.

FIG. 7 is a flow chart of a second method for training the text-to-logic language model of FIGS. 1 and 2 according to an example embodiment of the present disclosure.

FIG. 8 shows an example computing environment of the present disclosure in which the computing system of FIG. 1 may be enacted.

### DETAILED DESCRIPTION

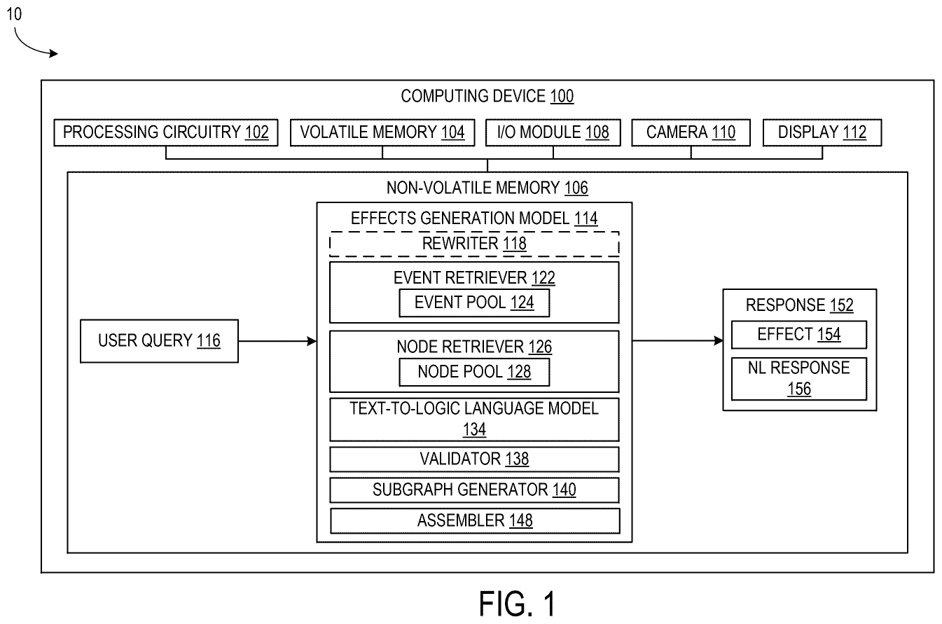

FIG. 1 shows a schematic view of a first example computing system 10 including a computing device 100 for generating an effect 154 using an effects generation model 114. The computing device 100 includes processing circuitry 102 (e.g., central processing units, or “CPUs”), volatile memory 104, non-volatile memory 106, an input/output (I/O) module 108, a camera 110, and a display 112. The different components are operatively coupled to one another. The non-volatile memory 106 stores instructions to execute the effects generation model 114 which is configured to receive a user query 116 and generate a response 152 including the effect 154 and a natural language response 156 based on the user query 116.

The effects generation model 114 may include a query rewriter 118 configured to rewrite the user query 116. The effects generation model 114 further includes an event retriever 122 configured to retrieve one or more events from an event pool 124 or a predefined database of events based on the user query 116, and a node retriever 126 configured to retrieve one or more nodes from a node pool 128 or a predefined database of nodes based on the user query 116. The effects generation model 114 further includes a text-to-logic language model 134 configured to generate domain-specific language (DSL) code based on the user query 116, the one or more events, and the one or more nodes. The effects generation model 114 also includes a validator 138 configured to validate the generated DSL code based on predefined validation criteria, and a subgraph generator 140 configured to generate a subgraph based on the generated DSL code. The effects generation model 114 further includes an assembler 148 which is configured to assemble the subgraph into a package, and generate the response 152 including the visual effect 154 and the natural language response 156. The visual effect 154 is generated by executing the assembled package.

The subgraphs are script graphs that each accomplish independent functions or behaviors, but through the selection and interconnection, can be nested within a main script graph of the effect, to thereby create visual scripting logic to implement the main script graph (including its subgraphs) for the entire effect. The visual scripting logic can be interpreted by a script interpreter. The script interpreter can interpret the visual scripting logic in real time, to enable a user to try out and modify the effect that has just been created, as described below.

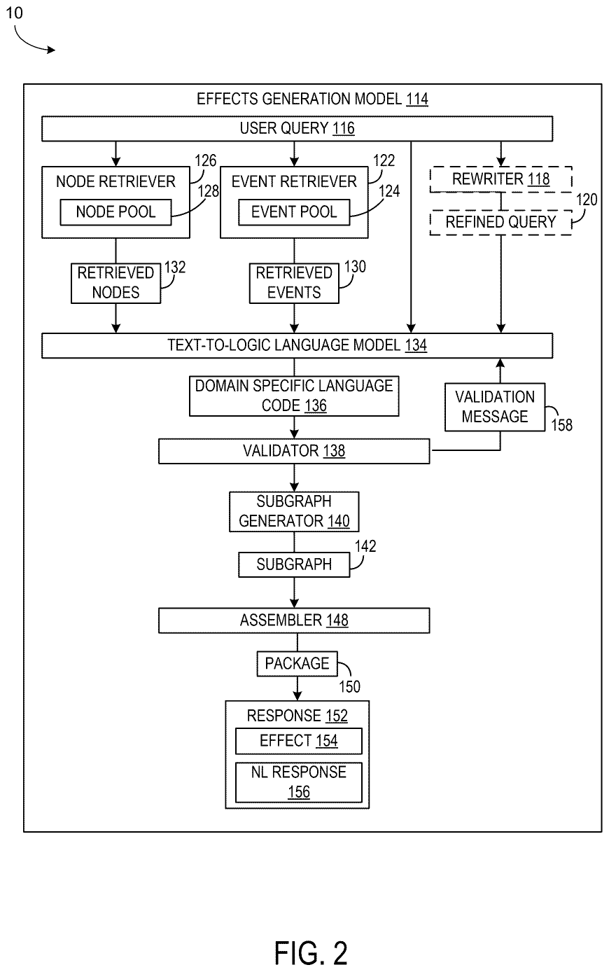

Referring to FIG. 2, the operations of the effects generation model 114 are described in further detail. The effects generation model 114 uses a modular approach to the automated generation of an effect 154 based on the user query 116, leveraging a text-to-logic language model 134 to interpret and guide the effect creation process. The effects generation model 114 receives a user query 116, which may mention various aspects of the desired effect. Responsive to receiving the user query 116, the query rewriter 118 may rewrite the user query 116 to generate a refined query 120 that may clarify the request of the user. The query rewriter 118 may be a language model, for example.

The user query 116 and/or the refined query 120 are inputted into an event retriever 122 and a node retriever 126 to retrieve events 130 and nodes 132, respectively. The retrieved events 130, the retrieved nodes 132, and the user query 116 and/or the refined query 120 are subsequently inputted into a text-to-logic language model 134 to generate domain-specific language (DSL) code 136. The retrieved events 130, the retrieved nodes 132, and the user query 116 and/or the refined query 120 that are inputted into the text-to-logic language model 134 may be written in natural language or formatted in machine-readable format.

The node retriever 126 may retrieve one or more nodes 132 from a node pool 128 comprising a database of predefined nodes. A node 132 refers to a unit of logic that defines a specific function, behavior, control, or interaction in the desired effect 154. Nodes may represent functional components such as triggers, animation controllers, effect states, movement controllers, and user interface (UI) elements. Nodes may be interconnected in events to facilitate complex interactions and mechanics, and they may pass data, including state information, between each other. Nodes may be configured to respond to events, execute animations, and track effect states. The node retriever 126 may be configured as a language model, or alternatively configured as a vector similarity search function configured to evaluate a similarity between nodes in the node pool 128 and the user query 116.

The event retriever 122 may retrieve one or more events 130 from an event pool 124 which comprises a database of predefined events. An event 130 refers to a change in a state, condition, or trigger occurring within a desired effect 154 that is represented by one node 132 or a linkage between two or more nodes 132. Each event 130 may be a prebuilt module that handles core functionalities, which may include facial expression detection, gesture recognition, object detection and tracking, pose estimation, or color detection, for example. The linkages may define input and output ports between pairs of linked nodes 132. Each event 130 may be executed by transmitting data or control signals from the output port of an originating node to an input port of one or more receiving nodes, thereby executing a predefined function or behavior of the effect 154. Attribute values may define conditions, thresholds, or parameters which determine how the events 130 are executed. A plurality of events may be connected with each other to generate the desired effect 154. The event retriever 122 may be configured as a language model, or alternatively configured as a vector similarity search function configured to evaluate a similarity between events in the event pool 124 and the user query 116.

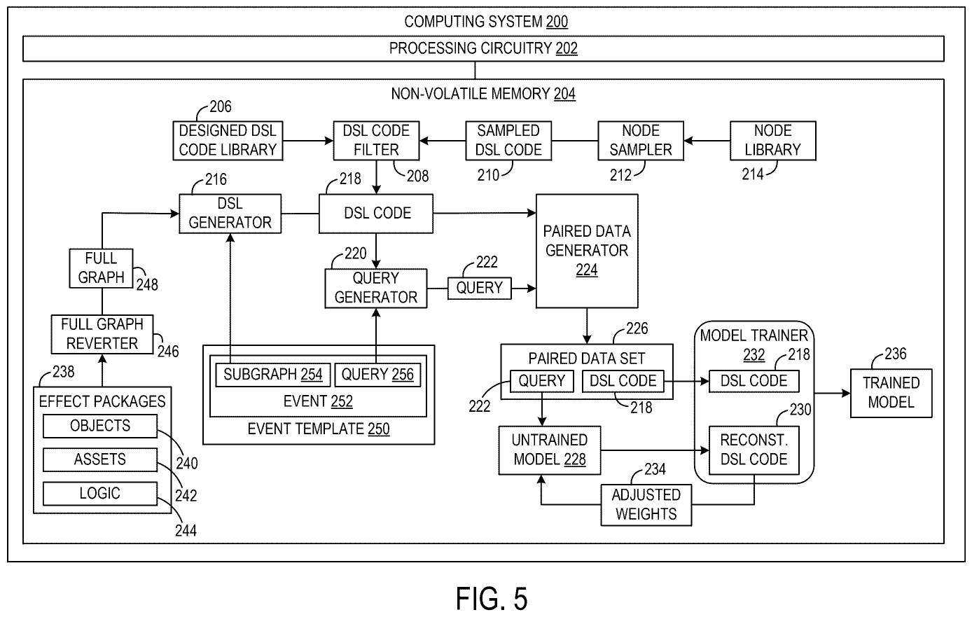

The text-to-logic language model 134 may be trained on a diverse database of paired user queries and DSL code of visual effects covering a wider range of user queries and visual effects, as described in further detail below with reference to FIG. 5. This training database acts as ground truth, providing the language model 134 with both simple and complex examples of how to translate natural language requests 116 into DSL code 136 that can be used to build a subgraph 142 for the desired effect 154.

The executable DSL code 136 programmatically instructs the execution of events including assets and entities, defining how the assets and entities should behave to generate the desired effect 154. The language used in the DSL code 136 is not particularly limited, and may be JSON, for example. The DSL code 136 bridges the gap between the user query 116 and the desired effect 154 by acting as an intermediary abstraction layer, thereby ensuring a robust system 10 for generating interactive effects 154.

Assets included in the DSL code 136 are preconfigured visual or generative elements that define the appearance and properties of the effect. They may include generative effects and textures, for example. Generative effects involve procedural modifications applied to the user's visual representation, such as an “eyebrow eraser,” which dynamically detects and modifies specific facial features. Textures are predefined visual patterns or color schemes, such as “vibrant red hat front view” or intricate makeup designs, which can be directly mapped onto entities or applied as overlays. These assets enable customization and creative variation within the generated visual effect 154.

Entities included in the DSL code 136 are interactive or placement-based components that represent discrete visual or functional objects within the visual effect 154. Entities may include physical props, stickers, foreground particles, and interactive controls. For example, physical props may include digital “hats” or “rabbit ears” which dynamically adjust their sizes and orientation to align with the user's head in real-time. A “hand sticker” may be placed on specific areas of the screen or anchored to user-detected movements. Animated sparkles or icons may float in the foreground visual environment. Interactive controls may include functional modules, such as a joystick controller, which enable user inputs to influence the behavior of the visual effect 154.

A validator 138 may filter the generated DSL code 136 to determine whether the generated DSL code 136 meets predefined validation criteria, such as valid syntax and grammar required for proper processing of the DSL code 136. Responsive to determining that the generated DSL code 136 does not meet the predefined validation criteria, the validator 138 may flag the generated DSL code 136 and generate a validation message 158, which may be inputted into the language model 134 in combination with the user query 116, retrieved events 130, and retrieved nodes 132, to refine the output of the generated DSL code 136.

Responsive to determining that the generated DSL code 136 meets the predefined validation criteria, the subgraph generator 140 converts the generated DSL code 136 into a subgraph 142. The final stage involves the assembler 148, which assembles the subgraph 142 and its associated assets and entities into an executable package 150. The assembler 148 ensures that the subgraph 142 generated from the DSL code 136 is properly interconnected, organized and optimized for execution on the front-end. The assembler 148 may deploy and execute the executable package 150 on the front-end system. This package 150 contains the resources, configurations, and connections for rendering the visual effect 154.

The assembler 148 may generate a final output response 152 including not only a preview of the visual effect 154 but also a natural language response 156, which provides a descriptive summary or relative guidance regarding the generated visual effect 154, offering the user a comprehensive overview of their generated visual effect 154. The visual effect 154 may be generated by rendering the visual effect 154 on a user interface on a social media platform, for example.

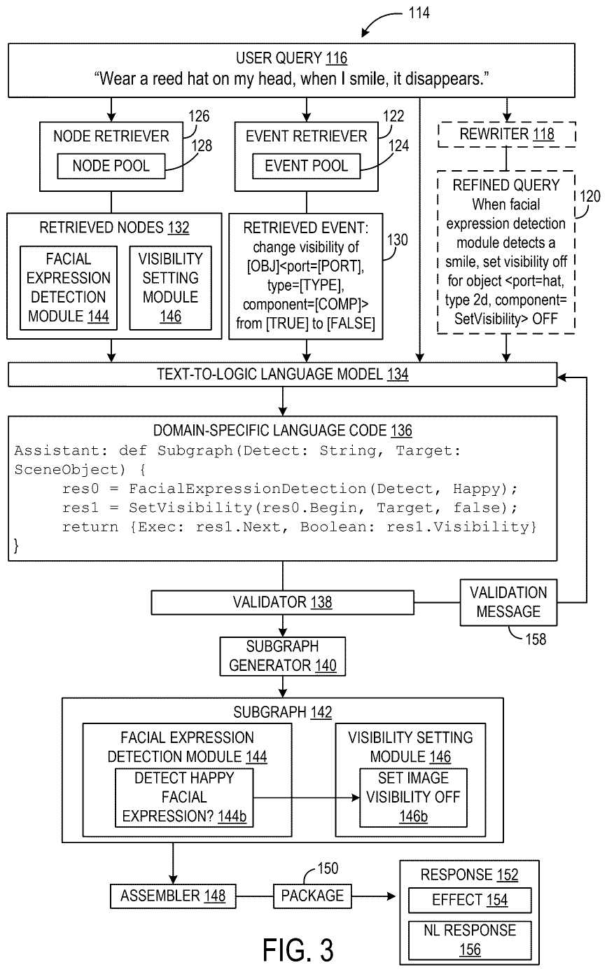

FIG. 3 illustrates the inputs and outputs of the query rewriter 118, the event retriever 122, the node retriever 126, the text-to-logic language model 134, and the subgraph generator 140 of FIGS. 1 and 2 in a first example. In this example, the user inputs a user query 116, “Wear a reed hat on my head, when I smile, it disappears.” In response, the event retriever 122 retrieves the event 130, “change visibility of [OBJ]<port=[PORT], type=[TYPE], component=[COMP]> from [TRUE] to [FALSE]” from the event pool 124, and the node retriever 126 retrieves the nodes 132, facial expression detection module 144 and visibility setting module 146, from the node pool 128. The rewriter 118 rewrites the user query 116 to recite, “When facial expression detection module detects a smile, set visibility off for object <port=hat, type 2d, component=SetVisibility>OFF”.

Some events in the event pool 124 may specify the movement of objects or a color change of an object. For example, a movement event may specify, in code, “move [OBJ]<port=[PORT], type=[TYPE], component=[COMP]> by [INCRE] in [SEC] seconds”. In other words, the movement event specifies the target object to be moved and the speed of its movement. A color change event may specify, in code, “change Color of [OBJ]<port=[PORT], type=[TYPE], component=[COMP]> from [FROM] to [TO]”. In other words, the color change event specifies the target object for the color change and the specified color that is to be changed into the desired color.

Other events in the event pool 124 may specify a trigger condition that is required to be triggered for one or more responses to be executed. The execution of these responses is not limited to a single structure and may follow various patterns. Responses may be performed sequentially, in parallel, or in a combination of both. Additionally, an event may dynamically switch between multiple responses based on the trigger condition, executing different responses under different circumstances. The execution flow may include elaborate branching pathways, where responses diverge into multiple event-driven sequences that may proceed independently or conditionally. These branching structures may incorporate combinations of sequential, parallel, and conditional executions.

Based on the inputted retrieved event 130, retrieved nodes 132, and refined query 120, the text-to-logic language model 134 generates DSL code 136 which specify a “facial expression detection” function to detect a happy facial expression, and a “set visibility” function for an image that is a target scene object. The subgraph generator 140 generates the subgraph 142 in accordance with the DSL code 136. The generated subgraph 142 includes the facial expression detection module 144 which includes a conditional logic 144b detecting whether a happy facial expression has been detected. The subgraph 142 also includes a visibility setting module 146 for the hat image, which has the “set image visibility off” function 146b which is activated when the facial expression detection module 144 detects a happy facial expression, upon which the visibility of the hat image is turned off.

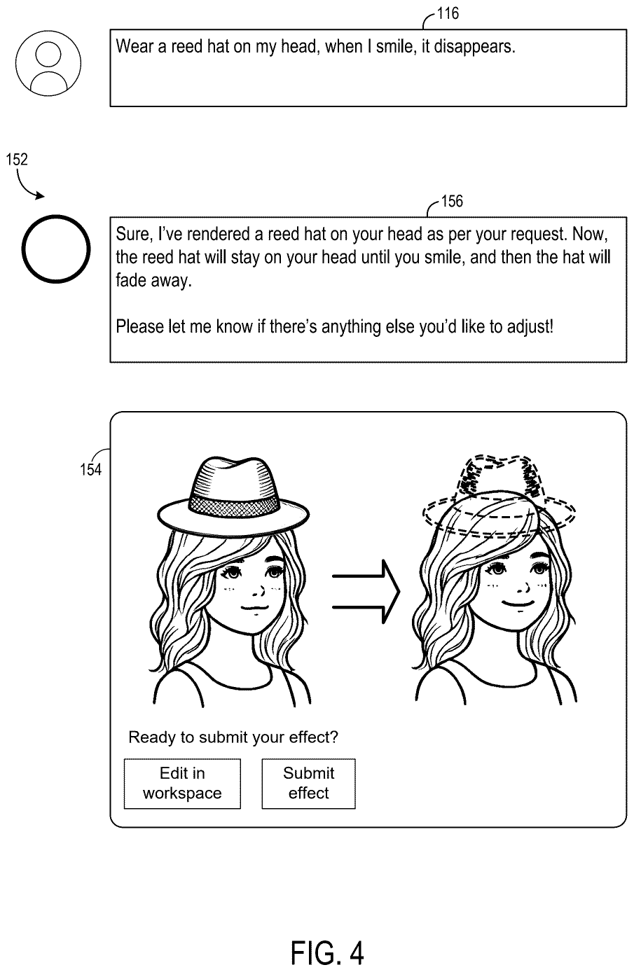

FIG. 4 illustrates the user interface in the first example of FIG. 3, in which the user inputs the user query, “Wear a reed hat on my head, when I smile, it disappears.” The user interface may be displayed on the display 112 of the computing device 100 of FIG. 1. Responsive to receiving the user query 116, the effects generation model 114 generates a response 152 including a preview of the generated effect 154 and a natural language response 156 which provides a descriptive summary or relative guidance regarding the generated visual effect 154, offering the user a comprehensive overview of their generated visual effect 154. In this example, the natural language response 156 explains that the reed hat will stay on the user's head until the user smiles, and then the hat will fade away. The response 152 also includes a prompt asking the user whether the ‘effect’ is ready to be submitted or edited further in the workspace. In other words, the response 152 invites a subsequent user query to modify the generated effect 154.

FIG. 5 shows a schematic view of a second example computing system 200 instantiating a model trainer 232 for the training of an untrained model 228 that is configured with the same architecture as the trained text-to-logic language model 134 described in FIGS. 1 and 2. The computing system 200 includes processing circuitry 202 (e.g., central processing units, or “CPUs”) and non-volatile memory 204 which stores instructions to execute a model trainer 232 to train the untrained model 228 to generate a trained text-to-logic language model 236. In this training system 200, a synthetic training data set 226 comprising pairs of synthetic queries 222 and DSL code 218 is generated and then used to train the untrained language model 228. Accordingly, the model trainer 232 obviates the need to use manually labeled training data for generating the trained text-to-logic language model 134.

In this training system 200, DSL code 218 is obtained from one or more sources. A query generator 220, which may be configured as a query-generating language model, receives input of the obtained DSL code 218 to generate a synthetic query 222 corresponding to the obtained DSL code 218. A paired data generator 224 subsequently pairs together the DSL code 218 and the synthetic query 222 corresponding to the DSL code 218 to generate a paired training data set 226 that is used to train the untrained model 228.

In one example of obtaining DSL code 218 for training the untrained model 228, a node sampler 212 may sample nodes from a node library 214 comprising predefined nodes to obtain sampled DSL code 210. A DSL code filter 208 may filter the sampled DSL code 210 based on predefined criteria to output the DSL code 218 to be included in the training data set 226. Additionally or alternatively, the DSL code filter 208 may filter DSL code in a designed DSL code library 206 that was manually written to output the DSL code 218 to be included in the training data set 226.

Additionally or alternatively, a series of event templates 250, each defining an event 252 comprising a subgraph 254 and an associated query 256, may be used. In each event 252 of the event template 250, the subgraph 254 may be inputted into a DSL generator 216 to generate a converted DSL code 218, and the query 256 may be inputted into the query generator 220 to rewrite the query 256 into a synthetic query 222 which corresponds to the converted DSL code 218.

Additionally or alternatively, existing predefined effect packages 238 comprising objects 240, assets 242, and logic 244 may be used to obtain the DSL code 218 to include in the training data set 226. As these effect packages 238 contain the resources, configurations, and connections for rendering effects, a full graph reverter 246 may revert the effect packages 238 to recover the full graphs 248 that were originally compiled to assemble the effect packages 238. The recovered full graphs 248 may be inputted into the DSL generator 216 to generate the DSL code 218 to include in the training data set 226.

Subsequent to generating the paired training data set 226 comprising pairs of DSL code 218 and synthetic queries 222 corresponding to the DSL code 218, for each pair of DSL code 218 and synthetic query 222, the synthetic query 222 is inputted into the untrained model 228 to generate reconstituted DSL code 230. The model trainer 232 minimizes the losses between the reconstituted DSL code 230 and the DSL code 218 from the training data set 226, and then adjusts the weights 234 of the untrained model 228 iteratively, based on the calculated losses, to generate the trained text-to-logic language model 236.

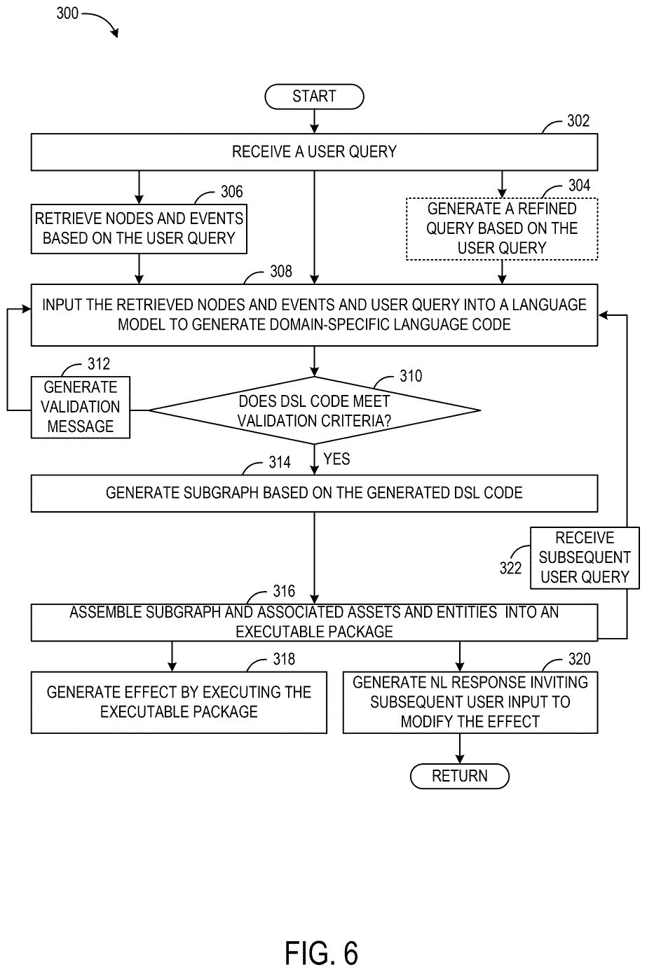

FIG. 6 shows a process flow diagram of a first example method 300 for generating an effect. The example method 300 may be executed by the processing circuitry 102 and memory 104 of the computing system 10 of FIG. 1. The example method 300 includes, at step 302, receiving a user query. Method 300 may include step 304 of generating a refined query based on the user query. At step 306, the method 300 includes retrieving nodes and events from a node pool and an event pool, respectively, based on the user query and/or the refined query.

The method 300 includes step 308 of inputting the retrieved nodes and events and the user query or refined query into a language model to generate DSL code. At step 310, the method 300 includes determining whether the generated DSL code meets predefined validation criteria. When it is determined at step 310 that the generated DSL code does not meet the validation criteria, the method 300 proceeds to step 312 to generate a validation message, and back to step 308 to input the validation message into the text-to-logic language model to refine the output of the DSL code.

When it is determined at step 310 that the generated DSL code meets the validation criteria, the method 300 proceeds to step 314 to generate a subgraph based on the generated DSL code. At step 316, the method 300 includes assembling the subgraph and its associated assets and entities into an executable package. At step 318, the method 300 includes generating the effect by executing the executable package, and at step 320, generating a natural language response inviting a subsequent user query to modify the effect. When, at step 322, a subsequent user query is received, the method 300 proceeds to step 306 of generating refined DSL code based on the subsequent user query.

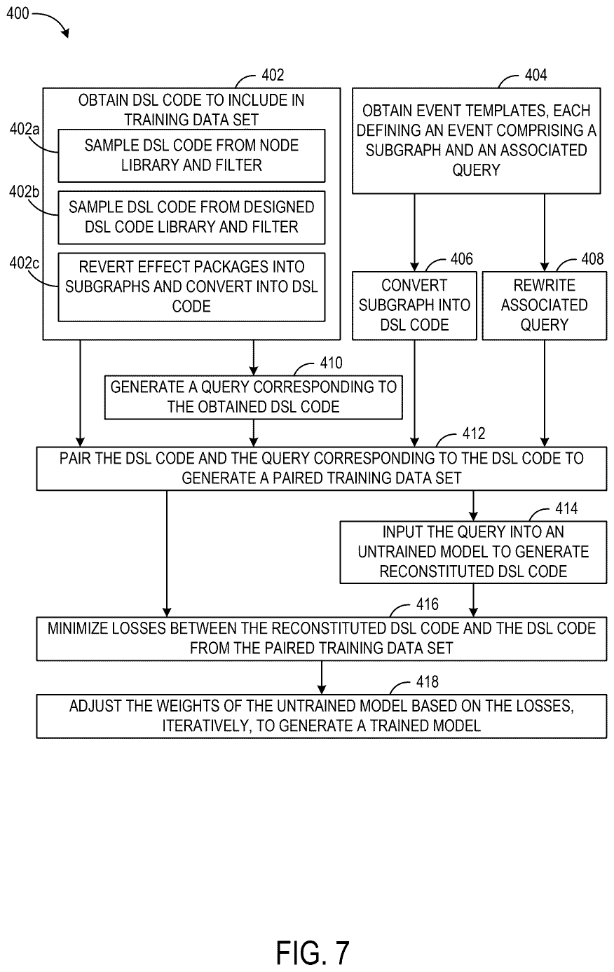

FIG. 7 shows a process flow diagram of a second example method 400 for generating an effect. The example method 400 may be executed by the processing circuitry 202 and memory 204 of the computing system 200 of FIG. 5. The example method 400 includes, at step 402, obtaining DSL code and/or step 404 of obtaining a plurality of event templates, each event template defining an event comprising a subgraph and an associated query. Step 402 of obtaining DSL code 402 may be achieved by step 402a of sampling DSL code from a node library and filtering the sampled DSL code to obtain the DSL code, step 402b of sampling DSL code from a manually written designed DSL code library and filtering the sampled DSL code to obtain the DSL code, and/or step 402c of reverting predefined effect packages to recover full graphs and generating the DSL code based on the reverted full graphs.

Subsequent to obtaining the DSL code in step 402, the method 400 may include step 410 generating a query corresponding to the obtained DSL code, and step 412 of pairing the obtained DSL code and the query corresponding to the obtained DSL code to generate a paired training data set.

Additionally or alternatively, subsequent to step 404 of obtaining a plurality of event templates, each event template defining an event comprising a subgraph and an associated query, method 400 proceeds to step 406 of converting the subgraph into DSL code, and step 408 of rewriting the associated query into a rewritten query to include in the training data set. At step 412, the method 400 includes pairing the converted DSL code and the rewritten query to generate a paired training data set.

For each pair of DSL code and query in the paired training data set, the method 400 includes step 414 of inputting the query into an untrained model to generate reconstituted DSL code, and step 416 of minimizing the losses between the reconstituted DSL code and the DSL code from the paired training data set. At step 418, the method 400 proceeds to adjusting the weights of the untrained model iteratively, based on the calculated losses, to generate the trained text-to-logic language model.

As described throughout herein, by leveraging language models to enable users to specify, customize, and refine their visual effects using natural language prompts, visual effects creation may be made more accessible to users. Users may achieve highly tailored visual effects without the complexity associated with traditional customization methods. Furthermore, the language models for generating the effects may be trained effectively and efficiently using synthetically generated training data, thereby obviating the need to prepare laboriously curated and labeled data sets for training effect generation models.

The above-described systems and methods not only simplify the process of creating visual effects, but also empower users to achieve professional-quality results in a fraction of the time. The systems and methods described herein may be broadly applied not only for enhancing user-generated content in social media, but also for enabling innovative solutions in entertainment, education, healthcare, and beyond.

In some embodiments, the methods and processes described herein may be tied to a computing system of one or more computing devices. In particular, such methods and processes may be implemented as a computer-application program or service, an Application Program Interface (API), a library, and/or other computer-program product. In some embodiments, the methods and processes described herein may be tied to a computing system of one or more computing devices. In particular, such methods and processes may be implemented as a computer-application program or service, an API, a library, and/or other computer-program product.

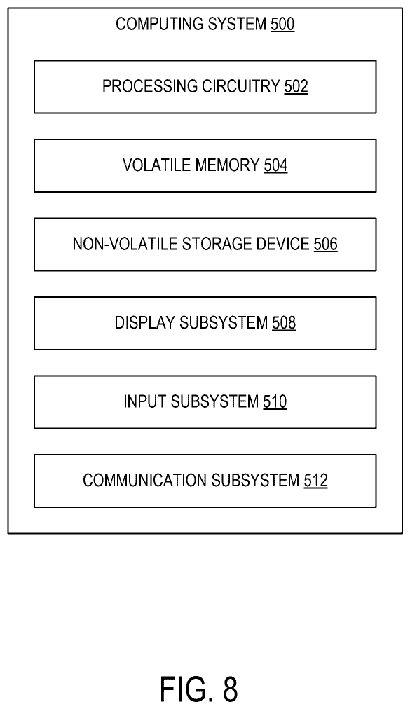

FIG. 8 schematically shows a non-limiting embodiment of a computing system 500 that can enact one or more of the methods and processes described above. Computing system 500 is shown in simplified form. Computing system 500 may embody the computing system 10 described above and illustrated in FIG. 1 or the computing system 200 described above and illustrated in FIG. 5. Components of computing system 500 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 500 includes processing circuitry 502, volatile memory 504, and a non-volatile storage device 506. Computing system 500 may optionally include a display subsystem 508, input subsystem 510, communication subsystem 512, and/or other components not shown in FIG. 8.

Processing circuitry 502 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 502 may be single-core or multi-core, and the instructions executed thereon may be configured for sequential, parallel, and/or distributed processing. Individual components of the processing circuitry 502 optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 502.

Non-volatile storage device 506 includes one or more physical devices configured to hold instructions executable by the processing circuitry 502 to implement the methods and processes described herein. When such methods and processes are implemented, the state of non-volatile storage device 506 may be transformed—e.g., to hold different data.

Non-volatile storage device 506 may include physical devices that are removable and/or built in. Non-volatile storage device 506 may include optical memory, semiconductor memory, and/or magnetic memory, or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to the non-volatile storage device 506.

Volatile memory 504 may include physical devices that include random access memory. Volatile memory 504 is typically utilized by processing circuitry 502 to temporarily store information during processing of software instructions. It will be appreciated that volatile memory 504 typically does not continue to store instructions when power is cut to the volatile memory 504.

Aspects of processing circuitry 502, volatile memory 504, and non-volatile storage device 506 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via processing circuitry 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices utilizing virtually any type of technology. Such display devices may be combined with processing circuitry 502, volatile memory 504, and/or non-volatile storage device 506 in a shared enclosure, or such display devices may be peripheral display devices.

When included, input subsystem 510 may comprise or interface with one or more user-input devices such as a keyboard, mouse, touch screen, camera, or microphone.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 500 to send and/or receive messages to and/or from other devices via a network such as the Internet.

The following paragraphs provide additional description of the subject matter of the present disclosure. One aspect provides a computing system for generating a visual effect, the computing system comprising processing circuitry and memory storing an effects generation model and instructions that, when executed, causes the processing circuitry to receive a user query, input the user query into a language model to generate domain-specific language code based on the user query, generate a subgraph based on the domain-specific language code, assemble the subgraph into a package, and generate the visual effect by executing the package. In this aspect, additionally or alternatively, one or more events may be retrieved from a database of predefined events based on the user query, and the one or more events and the user query may be inputted into the language model to generate the domain-specific language code. In this aspect, additionally or alternatively, the one or more events may be one or more changes in at least a state, condition, or trigger occurring within the visual effect. In this aspect, additionally or alternatively, one or more nodes may be retrieved from a database of predefined nodes based on the user query, and the one or more nodes, the one or more events, and the user query may be inputted into the language model to generate the domain-specific language code. In this aspect, additionally or alternatively, the one or more nodes may be interconnected in the one or more events. In this aspect, additionally or alternatively, the package may be assembled by assembling the subgraph and associated assets and entities, the assets may include textures, and the entities may include objects. In this aspect, additionally or alternatively, the language model may be trained on synthetic paired training data comprising pairs of domain-specific language code and synthetic queries generated by inputting the domain-specific language code into a query-generating language model. In this aspect, additionally or alternatively, the language model may be trained by, for each pair of domain-specific language code and synthetic query in the synthetic paired training data, inputting the synthetic query into an untrained model to generate reconstituted domain-specific language code, minimizing losses between the reconstituted domain-specific language code and the domain-specific language code from the synthetic paired training data, and adjusting weights of the untrained model to generate the language model. In this aspect, additionally or alternatively, the visual effect may be generated by rendering the visual effect on a user interface on a social media platform. In this aspect, additionally or alternatively, the one or more events may handle functionalities including at least one of facial expression detection, gesture recognition, object detection and tracking, pose estimation, or color detection.

Another aspect provides a computing method for generating a visual effect, the computing method comprising receiving a user query, inputting the user query into a language model to generate domain-specific language code based on the user query, generating a subgraph based on the domain-specific language code, assembling the subgraph into a package, and generating the visual effect by executing the package. In this aspect, additionally or alternatively, one or more events may be retrieved from a database of predefined events based on the user query, and the one or more events and the user query may be inputted into the language model to generate the domain-specific language code. In this aspect, additionally or alternatively, the one or more events may be one or more changes in at least a state, condition, or trigger occurring within the visual effect. In this aspect, additionally or alternatively, one or more nodes may be retrieved from a database of predefined nodes based on the user query, and the one or more nodes, the one or more events, and the user query may be inputted into the language model to generate the domain-specific language code. In this aspect, additionally or alternatively, the one or more nodes may be interconnected in the one or more events. In this aspect, additionally or alternatively, the package may be assembled by assembling the subgraph and associated assets and entities, the assets may include textures, and the entities may include objects. In this aspect, additionally or alternatively, the language model may be trained on synthetic paired training data comprising pairs of domain-specific language code and synthetic queries generated by inputting the domain-specific language code into a query-generating language model. In this aspect, additionally or alternatively, the language model In this aspect, additionally or alternatively, trained by, for each pair of domain-specific language code and synthetic query in the synthetic paired training data, inputting the synthetic query into an untrained model to generate reconstituted domain-specific language code, minimizing losses between the reconstituted domain-specific language code and the domain-specific language code from the synthetic paired training data, and adjusting weights of the untrained model to generate the language model. In this aspect, additionally or alternatively, the modular subgraphs may handle functionalities including at least one of facial expression detection, gesture recognition, object detection and tracking, pose estimation, or color detection.

Another aspect provides a computing system for generating a visual effect, the computing system comprising processing circuitry and memory storing an effects generation model and instructions that, when executed, causes the processing circuitry to receive a user query, retrieve one or more events from a database of predefined events based on the user query, generate domain-specific language code based on the user query and the one or more events, generate a subgraph based on the domain-specific language code, assemble the subgraph into a package, and generate the visual effect by executing the package, where the one or more events handle functionalities including at least one of facial expression detection, gesture recognition, object detection and tracking, pose estimation, or color detection.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for generating a visual effect, the computing system comprising:
processing circuitry and memory storing an effects generation model and instructions that, when executed, causes the processing circuitry to:
receive a user query;
input the user query into a language model to generate domain-specific language code based on the user query;
generate a subgraph based on the domain-specific language code;
assemble the subgraph into a package; and
generate the visual effect by executing the package.

2. The computing system of claim 1, wherein
one or more events are retrieved from a database of predefined events based on the user query; and
the one or more events and the user query are inputted into the language model to generate the domain-specific language code.

3. The computing system of claim 2, wherein the one or more events are one or more changes in at least a state, condition, or trigger occurring within the visual effect.

4. The computing system of claim 2, wherein
one or more nodes are retrieved from a database of predefined nodes based on the user query; and
the one or more nodes, the one or more events, and the user query are inputted into the language model to generate the domain-specific language code.

5. The computing system of claim 4, wherein the one or more nodes are interconnected in the one or more events.

6. The computing system of claim 1, wherein
the package is assembled by assembling the subgraph and associated assets and entities;
the assets include textures; and
the entities include objects.

7. The computing system of claim 1, wherein the language model is trained on synthetic paired training data comprising pairs of domain-specific language code and synthetic queries generated by inputting the domain-specific language code into a query-generating language model.

8. The computing system of claim 7, wherein the language model is trained by, for each pair of domain-specific language code and synthetic query in the synthetic paired training data, inputting the synthetic query into an untrained model to generate reconstituted domain-specific language code, minimizing losses between the reconstituted domain-specific language code and the domain-specific language code from the synthetic paired training data, and adjusting weights of the untrained model to generate the language model.

9. The computing system of claim 1, wherein the visual effect is generated by rendering the visual effect on a user interface on a social media platform.

10. The computing system of claim 1, wherein the one or more events handle functionalities including at least one of facial expression detection, gesture recognition, object detection and tracking, pose estimation, or color detection.

11. A computing method for generating a visual effect, the computing method comprising:
receiving a user query;
inputting the user query into a language model to generate domain-specific language code based on the user query;
generating a subgraph based on the domain-specific language code;
assembling the subgraph into a package; and
generating the visual effect by executing the package.

12. The computing method of claim 11, wherein
one or more events are retrieved from a database of predefined events based on the user query; and
the one or more events and the user query are inputted into the language model to generate the domain-specific language code.

13. The computing method of claim 12, wherein the one or more events are one or more changes in at least a state, condition, or trigger occurring within the visual effect.

14. The computing method of claim 12, wherein
one or more nodes are retrieved from a database of predefined nodes based on the user query; and
the one or more nodes, the one or more events, and the user query are inputted into the language model to generate the domain-specific language code.

15. The computing method of claim 14, wherein the one or more nodes are interconnected in the one or more events.

16. The computing method of claim 11, wherein
the package is assembled by assembling the subgraph and associated assets and entities;
the assets include textures; and
the entities include objects.

17. The computing method of claim 11, wherein the language model is trained on synthetic paired training data comprising pairs of domain-specific language code and synthetic queries generated by inputting the domain-specific language code into a query-generating language model.

18. The computing method of claim 17, wherein the language model is trained by, for each pair of domain-specific language code and synthetic query in the synthetic paired training data, inputting the synthetic query into an untrained model to generate reconstituted domain-specific language code, minimizing losses between the reconstituted domain-specific language code and the domain-specific language code from the synthetic paired training data, and adjusting weights of the untrained model to generate the language model.

19. The computing method of claim 11, wherein the modular subgraphs handle functionalities including at least one of facial expression detection, gesture recognition, object detection and tracking, pose estimation, or color detection.

20. A computing system for generating a visual effect, the computing system comprising:
processing circuitry and memory storing an effects generation model and instructions that, when executed, causes the processing circuitry to:
receive a user query;
retrieve one or more events from a database of predefined events based on the user query;
generate domain-specific language code based on the user query and the one or more events;
generate a subgraph based on the domain-specific language code;
assemble the subgraph into a package; and
generate the visual effect by executing the package, wherein
the one or more events handle functionalities including at least one of facial expression detection, gesture recognition, object detection and tracking, pose estimation, or color detection.
